(19) United States
(12) Patent Application Publication
(10) Pub. No.: US 2009/0240441 A1
(43) Pub. Date: Sep. 24, 2009

(54) SYSTEM AND METHOD FOR ANALYSIS AND PRESENTATION OF GENOMIC DATA

(75) Inventor: Stanley N. Lapidus, Bedford, NH (US)

Correspondence Address: COOLEY GODWARD KRONISH LLP;ATTN: Patent Group, Suite 1100, 777 - 6th Street, NW, WASHINGTON, DC, 20001, US

(73) Assignee: Helicos Biosciences Corporation, Cambridge, MA (US)

(21) Appl. No.: 12/052,492

(22) Filed: Mar. 20, 2008

(51) Int. Cl. G06F 19/00

(52) U.S. Cl. 702/20

(57) ABSTRACT

A method for analyzing genomic data that includes obtaining genomic sequence information from an anonymous individual, processing the information via a secure computerized algorithm, and presenting phenotypic information to the individual based upon the genomic sequence information.

### TECHNICAL FIELD

The present invention generally relates to bioinformatics and a system for analyzing and visualizing biological data. In particular, the invention relates to a system and method for analyzing genomic data while maintaining the privacy and anonymity of the user's genomic data.

### BACKGROUND INFORMATION

With the advent of rapid sequencing technologies, scientists are producing significant sequencing information. For example, the Human Genome Project resulted in a consensus sequence of the human genome that has served to increase interest in gene structure and function, both in humans and non-human species. Scientists have also recently completed the sequencing of many other genomes including, for example, the mouse, chicken, rat, and dog.

The massive volume of genetic information generated by next-generation sequencing technologies must now be translated into functional consequences. The data that result may be used to develop gene-based strategies for preventing, diagnosing, and treating disease.

Bioinformatics is the field of science concerning the application of computer science, mathematics, and information technology to model and analyze biological systems, especially systems involving genetic material. Analogous to the importance of internet security and personal privacy to most consumers of products and services sold via the internet, protection of genetic information will continue to be an important aspect of the genomics field as new applications for this data are discovered. This is especially true where individuals wish to have their personal genome sequenced and analyzed to better understand their ancestry and inherited traits, or for personalized medical treatment and disease risk analysis.

It thus would be desirable to provide a new system and method for analyzing genomic data while maintaining the privacy and anonymity of the user and their genomic data. The present invention provides such systems and methods.

### SUMMARY OF THE INVENTION

The present invention provides media for receiving and analyzing genomic information. The media include a computer-readable program code for receiving and storing an individual's genomic information such that there is no identification of the individual to the source providing the information. A medium of the invention also has a database that associates genomic data with possible phenotypic outcomes and a processor for accessing the database to generate phenotypic information for the individual based upon the genomic information.

In a particular aspect of the invention, the medium also includes an interface allowing communication of the phenotypic information to the individual in response to a user-defined query. The medium can also include computer readable code with at least one security feature to encrypt the information or that allows the individual to determine which phenotypic information is accessed by the code. Furthermore, the genomic information can be received from a third party or downloaded from a web-based server and the database can be updated periodically as new genetic data is discovered.

According to another embodiment of the present invention, a method for analyzing genomic data includes obtaining genomic sequence information from an anonymous individual, processing the information via a secure computerized algorithm, and presenting phenotypic information to the individual based upon the genomic sequence information.

In a further aspect of the invention, the method for analyzing genomic data includes obtaining a biological sample from the individual and determining the sequence of at least a portion of the individual's genome. The processing step can include accessing computer-readable code via a password-protected network. The information can be encrypted, and it can be transmitted to a remote computer and the processing and presenting steps occur on the remote computer.

According to another embodiment of the present invention, a computer system includes memory for storing genomic data, a database comprising data for associating genomic sequence information with phenotypic output, a processor for correlating the genomic information with potential phenotypic outcomes, and an interface for communicating said phenotypic outcome to a user.

### BRIEF DESCRIPTION OF THE DRAWINGS

For a fuller understanding of the nature and operation of various embodiments according to the present invention, reference is made to the following description taken in conjunction with the accompanying drawing figures which are not necessarily to scale and wherein like reference characters denote corresponding or related parts throughout the several views and wherein:

FIG. 1 is a schematic diagram depicting a method of providing personal genetic information to a user;

FIG. 2 is a schematic diagram depicting an exemplary system and method of the present invention for analyzing genomic data while maintaining the privacy and anonymity of the user; and

FIG. 3 is a schematic diagram depicting an alternative exemplary system and method of the present invention for analyzing genomic data while maintaining the privacy and anonymity of the user.

### DESCRIPTION

In addition to the initial interpretation of the raw sequence data provided by the Human Genome Project, scientists and researchers around the world are constantly adding interpretations of genetic sequences in the form of annotations, which are notations on the sequence data which describe the location of biologically meaningful features embedded in the data. Thus far, these feature annotations have included three basic types including: (1) single-base annotations such as the location of single-nucleotide polymorphisms (SNPs), (2) single-span annotations such as the location and extent of individual transposable elements, and (3) multi-span annotations such as the locations of a gene's complement of exons and introns as inferred from cDNA-to-genomic sequence alignments or predicted by gene-finding programs. These location-based feature annotations often possess annotations of their own, such as scores describing their believability, information about the analysis programs used to generate them, their type, and other descriptive data.

This genomic data can be described using any number of formats including a simple text-based format, however scientists can make better use of the information when it is presented in an interactive, graphical format. Genomic browsers provide a graphical user interface (“GUI”) for individuals to visualize and annotating a DNA sequence. One example of such a browser is the University of California at Santa Clara's Genome Browser (http://genome.ucsc.edu). These and similar Web sites provide valuable information, but are limited by the inability of an individual to apply this useful information to their own genetic code. Thus to gain the full benefit of genome project data, users require desktop software that can present the data in a fully interactive environment conducive to exploration and which also allows users to view their own custom data.

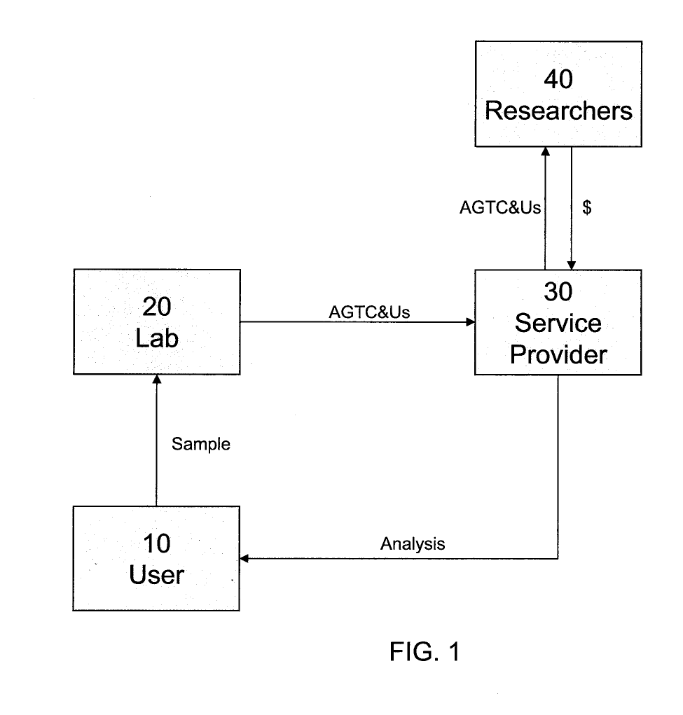

Several services are now being offered where individuals can obtain their personalized genetic information by sending a sample to a service provider who then in turn provides that individual some level of interpretation such as insights into their ancestry or predisposition to certain diseases. Examples of companies providing such a service include Navigenics (www.navigenics.com), 23and Me, Inc. (www.23and Me.com), and Helix Health (www.helixhealth.org). FIG. 1 shows a schematic of one example of a general flow diagram of information and data for such a service provider. In this example, the user 10 sends a sample to either an independent laboratory 20 or directly to a service provider 30. The sample is usually in the form of saliva on some type of swab or in a sterile tube. The lab 20 then processes that user's 10 entire genome or some subset thereof and then sends that genetic information to the service provider 30 for analysis and interpretation. Most of these service providers 30 employ their own team of experts to interpret the genetic data and their interpretation is limited to the collective knowledge of their team of experts. This analysis is then transmitted back to the user 10 in the form of a formal report or some type of Web-based GUI.

There are several drawbacks to these personalized genetic services. For example, the user 10 is never actually in control of his or her own genetic information. The lab 20 sends the genetic data to the service provider 30 and then that data is retained by that service provider 30. Even if the service provider 30 maintains a secure system, that security could still be compromised much in the way computer hackers obtain personal financial information from banks and other financial institutions.

Furthermore, these services are not in any way anonymous. The service provider 30 needs to know who the user 10 is so they can contact them with the results of their analysis. Personal genetic information is becoming increasingly valuable to researchers much like mailing lists are valuable for marketing purposes. This is especially true when the personal genetic information is combined with an individual's medical history. Since the service provider 30 retains this information, they can potentially sell the user's 10 genetic information and medical history to outside researchers 40 or pharmaceutical companies.

Another drawback is that the analysis performed by these service providers 30 cannot be customized to the user's specific preferences. Some of these service providers do not even sequence the user's entire genome. Instead, they only analyze a subset of the genome such as a predetermined number of single nucleotide polymorphisms (SNPs) that are chosen by the service provider's scientists. Others may sequence the entire genome but won't release all of the data, only the panel of gene tests designated by their team of experts. Each individual's interest or motivations for having his or her genome sequenced and analyzed may be different, and therefore not having the ability to seek the answers to specific questions the individual may have is a shortcoming of many of these services.

In addition, the study of genetics is not an exact science. Much of the data that we have available is subject to interpretation. As mentioned above, many of the annotations to the human genome are scored to describe their believability or reliability. When only one panel of experts is interpreting or analyzing genetic data, that analysis is inherently flawed because it only represents one opinion and not the collective wisdom of the entire worldwide scientific community. Thus, having the ability to consult multiple experts or seek out the preeminent experts in a particular field would be a desirable feature of personalized genetic counseling.

Finally, many of these services only provide a one-time service. Unfortunately for the individual who is paying for the analysis, genetic research is making strides virtually every single day. Therefore, as discoveries are made after the analysis is done, these discoveries are not applied retrospectively to past customers. Some may provide an ongoing subscription service so new discoveries can be applied to an individual's genetic data, but here again, the service provider's panel of expert would need to understand and follow these discoveries and would have to agree with the latest interpretations in order for the individual customer to benefit from these new discoveries. For example, an independent researcher may determine that a particular SNP is responsible for a particular form of cancer. The customer may be very interested in whether he or she has that particular SNP because of past medical history or because a family member had that particular form of cancer. However, the service provider's panel of experts may choose not to provide analysis of that trait because it is a rare disease that only effects a small percentage of the population.

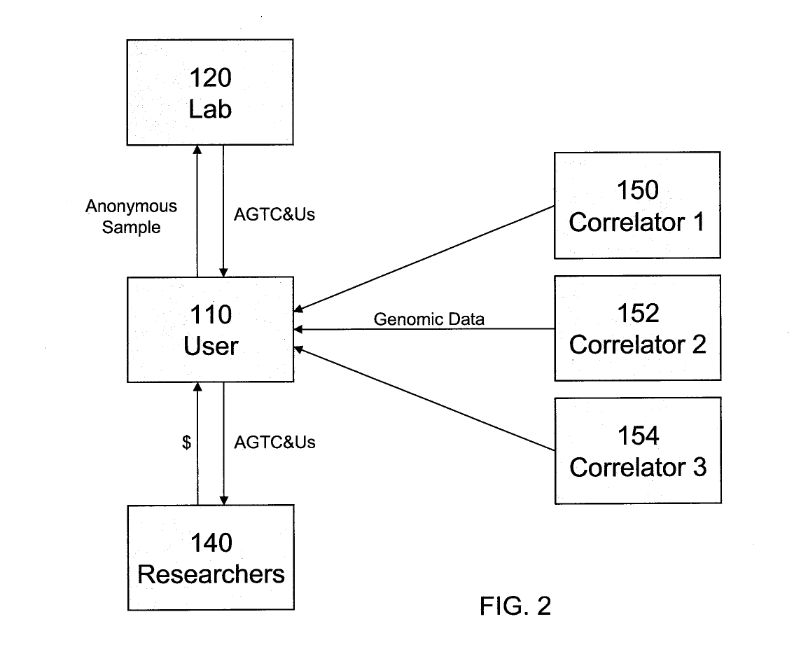

As indicated above, the present invention relates to a system and method for analyzing genomic data while maintaining the privacy and anonymity of the user and their genomic data. FIG. 2 depicts an overall schematic of an exemplary embodiment of the present invention. First, the user 110 purchases a sample collection kit. He or she then sends their biological sample (usually saliva) to an independent laboratory 120 through a common carrier that does not track shipments such as the United States Postal Service. The package containing the sample would have an anonymous ID number and/or username/password combination (chosen by the user 110) for the lab 120 to identify the sample. For example, the purchased sample collection kit can come with a secret ID number in the package and the user 110 can use that ID number to log onto the lab's 120 website to create a username and password. The package or sample collection kit could also include a barcode or other computerized encoding associated with that ID number to help ensure proper identification of the sample at the lab 120 while still maintaining its anonymity. The lab 120 that performs the sequencing would have no demographic information at all, only the anonymous ID.

After the package is shipped to the laboratory 120, the user 110 can check the laboratory's 120 website to track when the sample arrives. The user 110 can then periodically check the website to see where their sample is in the queue and when their sample has been processed. Once the sample has been sequenced, the user 110 can log on to the web site and downloads his or her genetic sequence (AGTC&Us) to the user's personal computer. After a successful download by the user 110, the data is erased from the laboratory's 120 computer along with the ID, username, and password. Therefore, the laboratory 120 never has any of the user's 110 demographic data or personal history and doesn't retain the user's 110 genetic data. It only produces a data file containing AGTC&Us and then sends it to an anonymous location (either electronically as noted above or in accordance with conventional techniques for anonymously transmitting electronic data, or by non-electronic procedures such as mailing to a post office box or other anonymous address). User 110 never lets his or her genomic information out of his or her control.

Now that the user 110 has his or her entire genomic sequence on their own personal computer, user 110 can choose how to have it analyzed. In one embodiment, the user 110 can purchase or download a personal genome browser (PGB) from any one of a number of correlators 150, 152, 154. A PGB generally contains computer readable code and a database (either local or remote) for associating genomic data with possible phenotypic outcomes. A processor can then access the database and generate phenotypic information for the user 110 based on their personal genetic data. The PGB also has an interface allowing communication of the phenotypic information based on a user-defined query.

The correlators 150, 152, 154 could be independent companies, scientific organizations such as the American Cancer Society, medical schools or institutions such as the Mayo Clinic or Johns Hopkins University, or any type of medical or genetic research facility. The PGBs offered by a correlator 150 can be designed by specialists for identifying defined verticals such as: diseases of aging (Alzheimer's, macular degeneration), cancer susceptibility (MLh1, BRCA), genetic defects, or nutrition/lifestyle advice. Alternatively, the PGBs could be offered as a subscription service so that as additional genetic information is learned about a particular disease, or a particular class of diseases, the user 110 can “rescan” their personal genetic data against newly learned genetic information.

In this system, the user 110 is in complete control of his or her personal genetic data and has the ability to keep that data anonymous and private on their personal computer. However, the user 110 also has the ability to sell or donate their data to researchers 140 if they so choose. This data can also be combined with clinical information, either anonymously or not, and then sold to researchers 140 for used in clinical studies, or possible enrollment in clinical trials. Furthermore, this data could be used for affirmative recruitment for, amongst other things, athletic franchises.

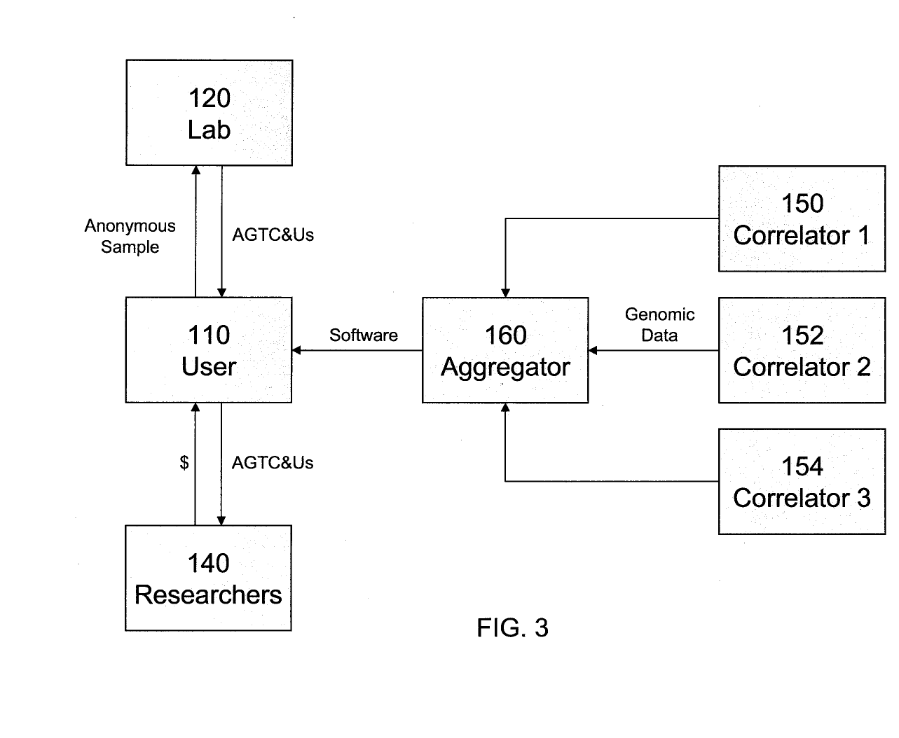

FIG. 3 depicts an alternative exemplary system of the present invention. The system shown in FIG. 3 is similar to the system shown in FIG. 2 except an aggregator 160 (intermediary) is included between the correlators 150, 152, 154 and the user 110. The aggregator 160 essentially assimilates the data available worldwide from a plurality of correlators 150, 152, 154, etc. and then sells the user 110 a “mega” PGB with a collection of all available genetic information. The aggregator 160 could be, for example, a major software company or a genetics company that has the ability to assess the reliability of the genetic data being aggregated. For example, if there were several different correlators worldwide with genetic data for colorectal cancer, organizations such as the National Institute of Health (NIH) and the American Cancer Society (ACS) could be ranked with higher reliability scores than less reputable data sources. As described above, the PGB could be a one-time service or a subscription service that is updated as additional genetic information is discovered. Also, any of the PGBs described herein can have links, or contact information for genetic counselors or physicians in the event certain diseases or an abnormality is detected.

The disclosed embodiments are exemplary. The invention is not limited by or only to the disclosed exemplary embodiments. Also, various changes to and combinations of the disclosed exemplary embodiments are possible and within this disclosure.

What is claimed is:

1. A medium for receiving and analyzing genomic information, the medium comprising:
a computer-readable program code for receiving and storing an individual's genomic information such that there is no identification of said individual to a source providing said information;
a computer-readable program code comprising a database for associating genomic data with possible phenotypic outcome;
a processor for accessing said database to generate phenotypic information for said individual based upon said genomic information; and
an interface allowing communication of said phenotypic information in response to a user-defined query.

2. The medium of claim 1, wherein said computer-readable code for receiving and storing an individual's genomic information contains at least one security feature to encrypt said information.

3. The medium of claim 1, wherein said genomic information is received from a third party provider.

4. The medium of claim 1, wherein said genomic information is downloaded from a web-based server.

5. The medium of claim 1, wherein said database is updated periodically.

6. The medium of claim 1, further comprising a computer-readable code that allows said individual to determine which phenotypic information is accessed by said code.

7. A method for analyzing genomic data, the method comprising the steps of:
obtaining genomic sequence information from an anonymous individual;
processing said information via a secure computerized algorithm; and
presenting to said individual phenotypic information based upon said genomic sequence information.

8. The method of claim 7, further comprising the step of obtaining a biological sample from said individual and determining the sequence of at least a portion of the individual's genome.

9. The method of claim 7, wherein said processing step comprises accessing computer-readable code via a password-protected network.

10. The method of claim 7, further comprising encrypting said information.

11. The method of claim 7, further comprising the step of supplying a medium according to claim 1.

12. The method of claim 7, wherein said information is transmitted to a remote computer and processing and presenting steps occur on said remote computer.

13. A computer system, comprising:
memory for storing genomic data;
a database comprising data for associating genomic sequence information with phenotypic output;
a processor for correlating said genomic information with potential phenotypic outcome; and
an interface for communicating said phenotypic outcome to a user.
